(19) United States
(12) Patent Application Publication
(10) Pub. No.: US 2025/0256921 A1
(43) Pub. Date: Aug. 14, 2025

(54) METHOD AND SYSTEM FOR DETECTING TRACK DEFECTS

(71) Applicant: Ocado Innovation Limited, Hatfield (GB)

(72) Inventors: Jose JIMENEZ CASAUX, Hatfield Hertfordshire (GB); Vasil YORDANOV, Sofia (BG)

(21) Appl. No.: 19/182,386

(22) Filed: Apr. 17, 2025

Related U.S. Application Data
(63) Continuation of application No. PCT/EP2023/078687, filed on Oct. 16, 2023.

(30) Foreign Application Priority Data
Oct. 18, 2022 (GB) 2215393.6

(51) Int. Cl. B65G 1/04; B61K 9/08

(52) U.S. Cl. CPC B65G 1/0464; B61K 9/08

(57) ABSTRACT

A storage and fulfilment system in which stacks of storage containers are arranged within a grid storage structure is known. The containers are accessed from above by load-handling devices operative on rails or tracks located on the top of the grid storage structure. There is a method and system for detecting defects on a track or rail on which a load-handling device moves.

### CROSS-REFERENCE TO RELATED APPLICATIONS

This Application is a continuation of PCT International Application PCT/EP2023/078687, filed on Oct. 16, 2023, which claims priority to UK Application No. GB2215393.6, filed on Oct. 18, 2022, the entire contents of each of which are hereby incorporated by reference.

### TECHNICAL FIELD

The present invention relates to a method and system for detecting defects on a track or rail on which a load-handling device moves.

### BACKGROUND

Some commercial and industrial activities require systems that enable the storage and retrieval of a large number of different products. WO2015/185628A describes a storage and fulfilment system in which stacks of storage containers are arranged within a grid storage structure. The containers are accessed from above by load-handling devices operative on rails or tracks located on the top of the grid storage structure.

To ensure the storage and fulfilment system runs reliably, it is important that the rails or tracks are free from defects. It is against this background that the present invention has been devised.

### SUMMARY

There is a computer-implemented method for determining a defect in a system, the system comprising a load-handling device, a first set of tracks extending in a first direction and a second set of tracks extending in a second direction which is transverse to the first direction, the load-handling device being configured to move on the tracks, wherein the load-handling device comprises a sensor configured to monitor movement of the load-handling device, wherein the method comprises: obtaining data that is generated by the sensor as the load-handling device moves along the first and/or second sets of tracks; determining that the data comprises abnormal data; and identifying a defect in a region of the first and/or second set of tracks by mapping the abnormal data to positioning data of the load-handling device, wherein the defect is identified if a number of times abnormal data maps with positioning data corresponding to the region, meets a first threshold. This means a defect in the system can be identified with a high degree of confidence.

The sensor may detect vibration of the load-handling device as it moves along the first and/or second sets of tracks. This means that defects in the system will be detected by the sensor.

The sensor may comprise an accelerometer, an inertial measurement unit, a gyroscope, an encoder or a torque sensor coupled to at least one wheel or axel of the load-handling device. This means data indicative of a system defect can be obtained.

Determining that data is abnormal comprises detecting that the data deviates from a mode, median, or mean, by a predetermined value, or exceeds a reference value. This means data indicative of a system defect can be identified.

Data generated by the sensor during acceleration and deceleration of the load-handling device may be excluded, such that the load-handling device is traveling at a constant velocity when determining that data comprises abnormal data. This means that acceleration/deceleration due only to a system defect will be detected by the sensor.

The sensor may only generate data in an axis transverse to a direction of movement of the load-handling device. This reduces the data processing and/or storage burdens when analyzing data generated by the sensor.

The sensor may generate data in a first axis corresponding to the first direction, a second axis corresponding to the second direction, and a third axis transverse to the first and second directions. This increases accuracy when detecting a system defect.

The first threshold may be a number or a percentage value, and optionally the percentage value may comprise a ratio of the number of times abnormal data maps with positioning data corresponding to the region over a number of times positioning data corresponds to the region. This means different use contexts can be taken into account when identifying a system defect.

The defect may be verified if a number of times positioning data corresponds to the region, meets a second threshold. This ensures the region has been sampled a sufficient number of times before identifying a system defect.

The system may comprise a plurality of load-handling devices, wherein the defect is verified if, for the plurality of load-handling devices, the number of times abnormal data maps with positioning data corresponding to the region, meets a third threshold. This increases confidence that a defect has been identified and rules out faulty sensors and/or errors when processing data from the sensors.

The defect may be verified, if, for the plurality of load-handling devices, a number of times positioning data corresponds to the region, meets a fourth threshold. This ensures the region has been sampled a sufficient number of times before identifying a system defect.

The system may comprise a plurality of load-handling devices, wherein the method may further comprise determining a percentage of unique load-handling devices for which the data comprises abnormal data in the region to define a first value, and verifying that a defect is in the region if the first value exceeds a fifth threshold. This further increases confidence that a defect has been identified and rules out faulty sensors and/or errors when processing data from the sensors.

The system may comprise a plurality of load-handling devices, wherein the method may further comprise, determining a total number of unique load-handling devices with positioning data corresponding to the region to define a second value, and verifying that a defect is in the region if the second value exceeds a sixth threshold. This ensures the region has been sampled a sufficient number of times before identifying a system defect.

The second, third, fourth, fifth, and sixth thresholds may each be met to verify that a defect is in the region. This maximizes confidence that a defect has been identified.

The method may further comprise determining a type of the defect by detecting a corresponding unique pattern in the data. This means the nature of a subsequent action and/or repair can be determined without first inspecting the system.

A type of the defect may comprise at least one of, debris on the first and/or second sets of tracks, misalignment along and/or between the first and/or second sets of tracks, a damaged section on first and/or second sets of tracks, and a damaged intersection along and/or between the first and/or second sets of tracks. This means the method can detect a wide variety of defects that adversely affect the reliable operation of the system.

The first and second set of tracks may be in a substantially horizontal plane to form a grid comprising a plurality of grid spaces, to form a plurality of vertical storage locations beneath the grid for containers to be stacked between and be guided by uprights in a vertical direction through the plurality of grid spaces, and optionally wherein the or each load-handling device is configured to lift a container from a vertical storage location beneath the grid and/or lower a container into a vertical storage location. This means reliable operation of the system is ensured.

The region may comprise a grid space. This means an operationally problematic area in the system can be identified. The method may further comprise reconfiguring the system to avoid operating load-handling devices in the grid space. This means the system can be run in a way that minimizes the risk of failure, such as a load-handling device falling over due to the defect in the grid space.

The data may comprise a plurality of average values, wherein each average value is derived from the sensor when the load-handling device is moving across a respective grid space. This helps isolate a grid space in which the system defect is present.

The method is performed over a predefined period of time. This means the system can be evaluated and compared periodically for defects.

The method may further comprise generating a map, wherein the map indicates regions with defects within the system. This means defects can be readily located within the system.

There is a computer program comprising instructions which, when the program is executed by a computer, cause the computer to carry out the method of the above aspects.

There is a data processing system comprising a processor configured to carry out the method of the above aspects.

There is system comprising: a load-handling device, a first set of tracks extending in a first direction and a second set of tracks extending in a second direction which is transverse to the first direction, the load-handling device being configured to move on the tracks, wherein the load- handling device comprises a sensor configured to monitor movement of the load-handling device; and the data processing system of the above aspect.

There is a map, wherein the map is generated using the method of the above aspects, the computer program of the above aspect, or the system of the above aspects, the map indicating regions with defects within the system.

### BRIEF DESCRIPTION OF DRAWINGS

The present invention is described with reference to one or more exemplary embodiments as depicted in the accompanying drawings, wherein:

FIG. 1 shows a storage structure and containers;

FIG. 2 shows track on top of the storage structure illustrated in FIG. 1;

FIG. 3 shows load-handling devices on top of the storage structure illustrated in FIG. 1;

FIG. 4 shows a single load-handling device with container-lifting means in a lowered configuration;

FIGS. 5A and 5B show cutaway views of a single load-handling device with container-lifting means in a raised and a lowered configuration;

FIG. 6 shows a known load-handling device showing the X-direction and Y-direction position sensors in the form of “fifth” wheels mounted thereon;

FIG. 7 shows a diagram of a movement sensor and positioning system for a load-handling device, according to an embodiment;

FIG. 8 shows communication between the load hand device and the master controller over a network, according to an embodiment;

FIG. 9 shows a method for determining a defect in a system comprising tracks and a load-handling device, according to an embodiment;

FIG. 10 shows a method for verifying a defect in a system comprising tracks and load-handling devices, according to an embodiment;

FIG. 11 shows a method for determining a defect in a system comprising tracks and load-handling devices, according to an embodiment; and

FIG. 12 shows a “heat” map indicating where defects are located in the system, according to an embodiment.

### DETAILED DESCRIPTION

Online retail businesses selling multiple product lines, such as online grocers and supermarkets, require systems that can store tens or hundreds of thousands of different product lines. The use of single-product stacks in such cases can be impractical since a vast floor area would be required to accommodate all of the stacks required. Furthermore, it can be desirable to store small quantities of some items, such as perishables or infrequently ordered goods, making single-product stacks an inefficient solution.

International patent application WO98/049075A (Autostore), the contents of which are incorporated herein by reference, describes a system in which multi-product stacks of containers are arranged within a frame structure.

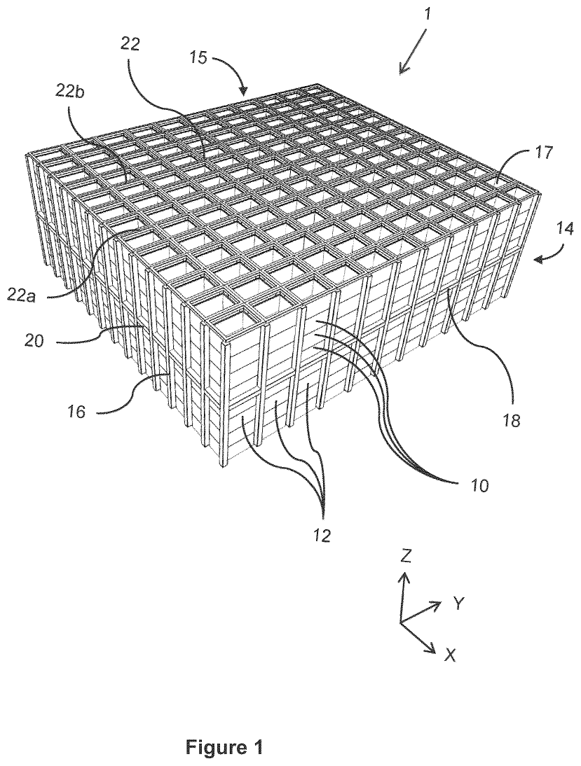

PCT Publication No. WO2015/185628A (Ocado) describes a further known storage and fulfilment system in which stacks of containers are arranged within a grid framework structure. The containers are accessed by one or more load-handling devices, otherwise known as “bots”, operative on tracks located on the top of the grid framework structure. A system of this type is illustrated schematically in FIGS. 1 to 3 of the accompanying drawings.

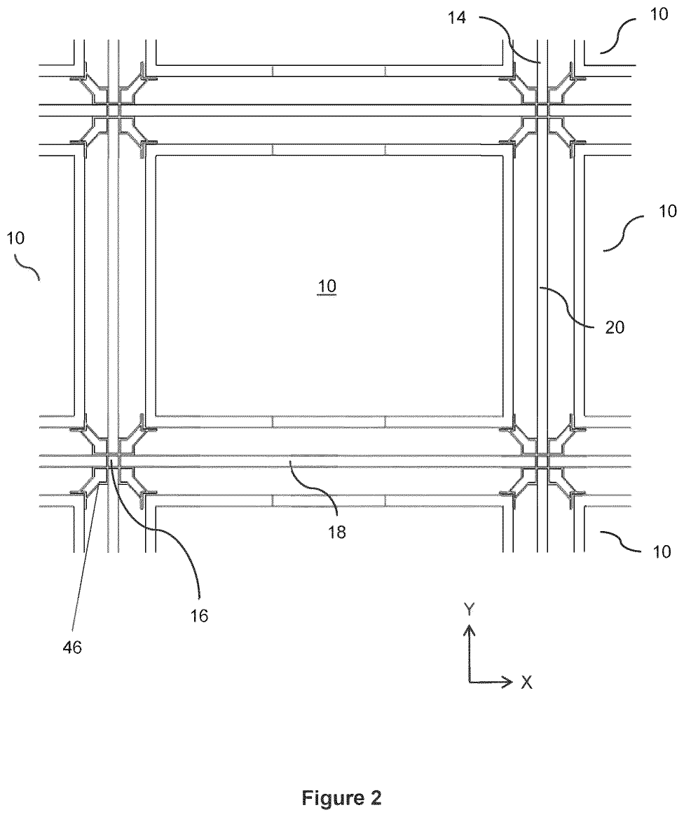

As shown in FIGS. 1 and 2, stackable containers 10, also known as “bins”, are stacked on top of one another to form stacks 12. The stacks 12 are arranged in a grid framework structure 14, e.g. in a warehousing or manufacturing environment. The grid framework structure 14 is made up of a plurality of storage columns or grid columns. Each grid in the grid framework structure has at least one grid column to store a stack of containers. FIG. 1 is a schematic perspective view of the grid framework structure 14, and FIG. 2 is a schematic top-down view showing a stack 12 of bins 10 arranged within the framework structure 14. Each bin 10 typically holds a plurality of product items (not shown). The product items within a bin 10 may be identical or different product types depending on the application.

The grid framework structure 14 comprises a plurality of upright members 16 that support horizontal members 18, 20. A first set of parallel horizontal grid members 18 is arranged perpendicularly to a second set of parallel horizontal members 20 in a grid pattern to form a horizontal grid structure 15 supported by the upright members 16. The members 16, 18, 20 are typically manufactured from metal. The bins 10 are stacked between the members 16, 18, 20 of the grid framework structure 14, so that the grid framework structure 14 guards against horizontal movement of the stacks 12 of bins 10 and guides the vertical movement of the bins 10.

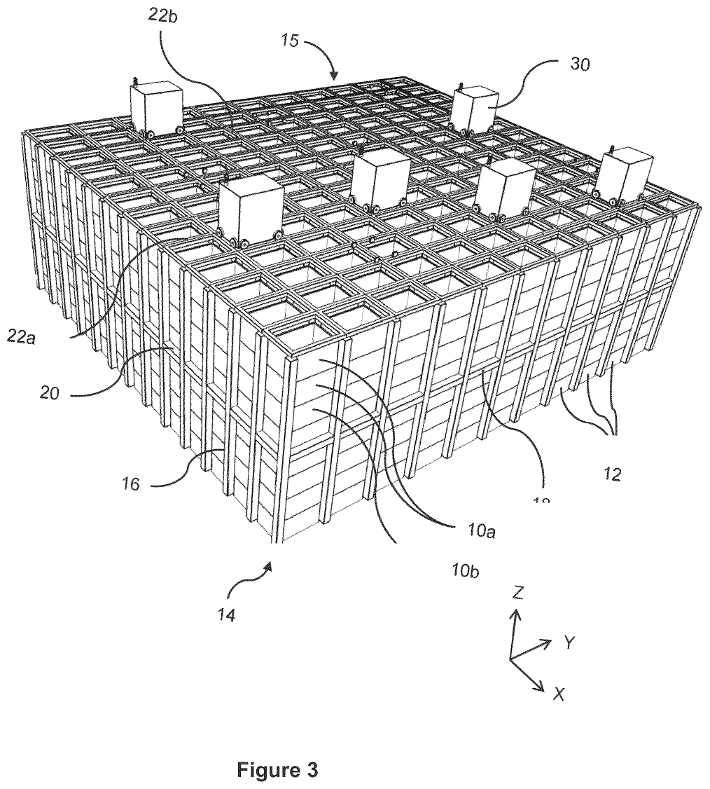

The top level of the grid framework structure 14 comprises a grid or grid structure 15, including rails 22 arranged in a grid pattern across the top of the stacks 12. Referring to FIG. 3, the rails or tracks 22 guide a plurality of load-handling devices 30. A first set 22a of parallel rails 22 guide movement of the robotic load-handling devices 30 in a first direction (e.g. an X-direction) across the top of the grid framework structure 14. A second set 22b of parallel rails 22, arranged perpendicular to the first set 22a, guide movement of the load-handling devices 30 in a second direction (e.g. a Y-direction), perpendicular to the first direction. In this way, the rails 22 allow the robotic load-handling devices 30 to move laterally in two dimensions in the horizontal X-Y plane. A load-handling device 30 can be moved into position above any of the stacks 12.

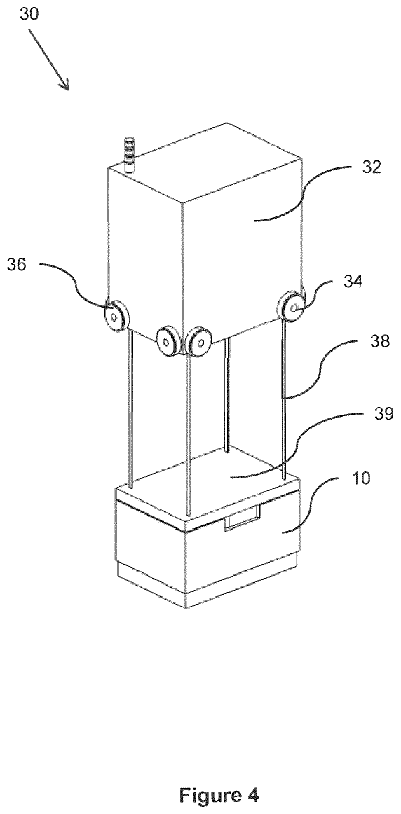

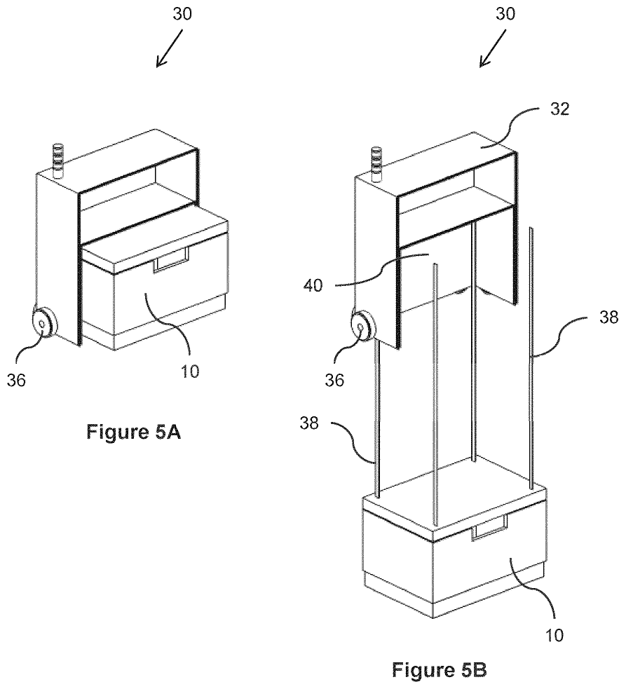

A known form of load-handling device 30—shown in FIGS. 4, 5A and 5B—is described in PCT Patent Publication No. WO2015/019055 (Ocado), hereby incorporated by reference, where each load-handling device 30 covers a single grid space 17 of the grid framework structure 14. This arrangement allows a higher density of load handlers and thus a higher throughput for a given sized system.

The load-handling device 30 comprises a vehicle 32, which is arranged to travel on the rails 22 of the frame structure 14. A first set of wheels 34, consisting of a pair of wheels 34 on the front of the vehicle 32 and a pair of wheels 34 on the back of the vehicle 32, is arranged to engage with two adjacent rails of the first set 22a of rails 22. Similarly, a second set of wheels 36, consisting of a pair of wheels 36 on each side of the vehicle 32, is arranged to engage with two adjacent rails of the second set 22b of rails 22. Each set of wheels 34, 36 can be lifted and lowered so that either the first set of wheels 34 or the second set of wheels 36 is engaged with the respective set of rails 22a, 22b at any one time. For example, when the first set of wheels 34 is engaged with the first set of rails 22a and the second set of wheels 36 is lifted clear from the rails 22, the first set of wheels 34 can be driven, by way of a drive mechanism (not shown) housed in the vehicle 32, to move the load-handling device 30 in the X-direction. To achieve movement in the Y-direction, the first set of wheels 34 is lifted clear of the rails 22, and the second set of wheels 36 is lowered into engagement with the second set 22b of rails 22. The drive mechanism can then be used to drive the second set of wheels 36 to move the load-handling device 30 in the Y direction.

The load-handling device 30 is equipped with a lifting device, e.g. a crane mechanism, to lift a storage container from above. The lifting device comprises a winch tether or cable 38 wound on a spool or reel (not shown) and a gripper device 39. The lifting device shown in FIG. 4 comprises a set of four lifting tethers 38 extending in a vertical direction. The tethers 38 are connected at or near the respective four corners of the gripper device 39, e.g. a lifting frame, for releasable connection to a storage container 10. For example, a respective tether 38 is arranged at or near each of the four corners of the lifting frame. The gripper device 39 is configured to releasably grip the top of a storage container 10 to lift it from a stack of containers in a storage system of the type shown in FIGS. 1 and 2. For example, the lifting frame 39 may include pins (not shown) that mate with corresponding holes (not shown) in the rim that forms the top surface of bin 10, and sliding clips (not shown) that are engageable with the rim to grip the bin 10. The clips are driven to engage with the bin 10 by a suitable drive mechanism housed within the lifting frame 39, powered and controlled by signals carried through the cables 38 themselves or a separate control cable (not shown).

To remove a bin 10 from the top of a stack 12, the load-handling device 30 is first moved in the X-and Y-directions to position the gripper device 39 above the stack 12. The gripper device 39 is then lowered vertically in the Z-direction to engage with the bin 10 on the top of the stack 12, as shown in FIGS. 4 and 5B. The gripper device 39 grips the bin 10, and is then pulled upwards by the cables 38, with the bin 10 attached. At the top of its vertical travel, the bin 10 is held above the rails 22 accommodated within the vehicle body 32. In this way, the load-handling device 30 can be moved to a different position in the X-Y plane, carrying the bin 10 along with it, to transport the bin 10 to another location. On reaching the target location (e.g. another stack 12, an access point in the storage system, or a conveyor belt) the bin or container 10 can be lowered from the container receiving portion and released from the grabber device 39. The cables 38 are long enough to allow the load-handling device 30 to retrieve and place bins from any level of a stack 12, e.g. including the floor level.

As shown in FIG. 4, a plurality of identical load-handling devices 30 is provided so that each load-handling device 30 can operate simultaneously to increase the system's throughput. The system illustrated in FIG. 4 may include specific locations, known as ports, at which bins 10 can be transferred into or out of the system. An additional conveyor system (not shown) is associated with each port so that bins 10 transported to a port by a load-handling device 30 can be transferred to another location by the conveyor system, such as a picking station (not shown). Similarly, bins 10 can be moved by the conveyor system to a port from an external location, for example, to a bin-filling station (not shown), and transported to a stack 12 by the load-handling devices 30 to replenish the stock in the system.

Each load-handling device 30 can lift and move one bin 10 at a time. The load-handling device 30 has a container-receiving cavity or recess 40, in its lower part. The recess 40 is sized to accommodate the container 10 when lifted by the lifting mechanism, as shown in FIGS. 5A and 5B. When in the recess, the container 10 is lifted clear of the rails 22 beneath, so that the vehicle 32 can move laterally to a different grid location.

If it is necessary to retrieve a bin 10b (“target bin”) that is not located on the top of a stack 12, then the overlying bins 10a (“non-target bins”) must first be moved to allow access to the target bin 10b. This is achieved by an operation referred to hereafter as “digging”. Referring to FIG. 3, during a digging operation, one of the load-handling devices 30 lifts each non-target bin 10a sequentially from the stack 12 containing the target bin 10b and places it in a vacant position within another stack 12. The target bin 10b can then be accessed by the load-handling device 30 and moved to a port for further transportation.

Each of the provided load-handling devices 30 is remotely operable under the control of a central computer. Each individual bin 10 in the system is also tracked so that the appropriate bins 10 can be retrieved, transported and replaced as necessary. For example, during a digging operation, each non-target bin location is logged so that the non-target bin 10a can be tracked.

Wireless communications and networks may be used to provide the communication infrastructure from the master controller, e.g. via one or more base stations, to one or more load-handling devices operative on the grid structure. In response to receiving instructions from the master controller, a controller in the load-handling device is configured to control various driving mechanisms to control the movement of the load-handling device. For example, the load-handling device may be instructed to retrieve a container from a target storage column at a particular location on the grid structure. The instruction can include various movements in the X-Y plane of the grid structure 15. As previously described, once at the target storage column, the lifting mechanism can be operated to grip and lift the storage container 10. Once the container 10 is accommodated in the container-receiving space 40 of the load-handling device 30, it is subsequently transported to another location on the grid structure 15, e.g. a “drop-off port”. At the drop-off port, the container 10 is lowered to a suitable pick station to allow retrieval of any item in the storage container. Movement of the load-handling devices 30 on the grid structure 15 can also involve the load-handling devices 30 being instructed to move to a charging station, usually located at the periphery of the grid structure 15.

To maneuver the load-handling devices 30 on the grid structure 15, each of the load-handling devices 30 is equipped with motors for driving the wheels 34, 36. The wheels 34, 36 may be driven via one or more belts connected to the wheels or driven individually by a motor integrated into the wheels. For a single-cell load-handling device (where the footprint of the load-handling device 30 occupies a single grid cell 17), and the motors for driving the wheels can be integrated into the wheels due to the limited availability of space within the vehicle body. For example, the wheels of a single-cell load-handling device are driven by respective hub motors. Each hub motor comprises an outer rotor with a plurality of permanent magnets arranged to rotate about a wheel hub comprising coils forming an inner stator.

The system described with reference to FIGS. 1 to 4 has many advantages and is suitable for a wide range of storage and retrieval operations. In particular, it allows very dense storage of products and provides a very economical way of storing a wide range of different items in the bins 10 while also allowing reasonably economical access to all of the bins 10 when required for picking.

In storage systems of the type shown in FIGS. 1 to 3, it is useful to determine an accurate position of a given load-handling device 30 operating on the grid structure 15. Each load-handling device 30 is sent control signals, e.g. in the form of a motion control profile, to move along a predetermined path from one location to another on the grid structure. For example, a given load-handling device 30 may be instructed to move to a particular location in the grid structure 15 to lift a target container from the stack of containers at the particular location. With multiple such devices 30 moving along respective trajectories on the grid structure 15, it is useful to know the accurate position of each given load-handling device 30, e.g. relative to the grid structure 15, so that the predetermined trajectories can be monitored in real-time against the “actual” position of the corresponding load-handling device 30. For example, the one or more trajectories may be adjusted, and/or the control signals for sending to a device 30 to follow the corresponding trajectory may be adjusted, such that the device 30 reaches the target location sufficiently accurately and/or avoids other devices 30 following their respective trajectories.

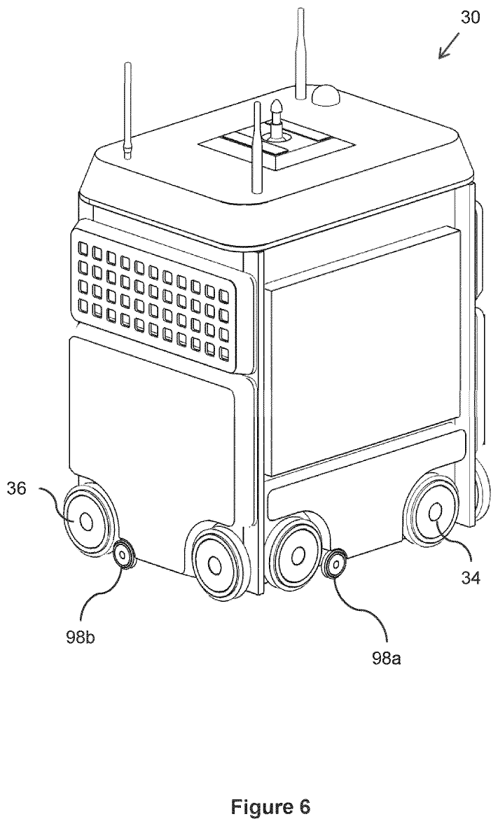

FIG. 6 shows a known load-handling device 30 with one or more position sensors 98a, 98b to measure the position of the load-handling device relative to the grid structure 15. The position sensors 98a, 98b each comprises a so-called “fifth” wheel in the sense that an additional fifth wheel is present amongst each of the first and second set of wheels for monitoring the position of the load-handling device in the first direction and the second direction on the grid structure, respectively.

As shown in FIG. 6, a first “fifth” wheel 98a is mounted adjacent to one of the first set of wheels 34 and a second “fifth” wheel 98b is mounted adjacent to one of the second set of wheels 36. The first “fifth” wheel 98a corresponding to a first position sensor is configured to engage with the rails (or “tracks”) 22 when the load-handling device 30 is travelling in the first direction, such that rotation of the first “fifth” wheel is an indication of the position and direction of travel of the load-handling device 30 with respect to time. Similarly, the second “fifth” wheel 98b corresponding to a second position sensor is configured to engage with the track 22 when the load-handling device 30 is travelling in the second direction, such that rotation of the second “fifth” wheel is an indication of the position and direction of travel of the load-handling device 30 in the second direction with respect to time. The first direction and second direction can respectively be the X-and Y-direction along the tracks 22 as described.

In FIG. 6, each of the one or more position sensors 98a, 98b comprises an incremental encoder comprising a rotary electromechanical device that generates pulses when the respective “fifth” wheel rotates. For example, a pulse is generated for a predetermined amount of angular rotation of the “fifth” wheel. Thus, the pulses indicate the position and direction of rotation of the “fifth” wheel 98a, 98b, which can be translated into the displacement of the load-handling device 30 relative to the grid structure 15. The “fifth” wheel is mounted on an arm and downwardly biased to engage with the tracks 22 of the grid structure 15. As an alternative to the “fifth” wheel 98a, 98b, the incremental encoder can be used to generate pulses as any one wheel of the sets of wheels 34, 36, rotates to determine the position of the load-handling device 30.

Reliable operation of the storage and fulfilment system described above with reference to FIGS. 1 to 6 depends on load-handling devices moving unimpeded along the tracks. In practice, the tracks can develop defects that impede the movement of the load-handling device. For example, debris, such as scraps of metal, nuts or bolts may become lodged in the tracks. Alternatively, the first and/or second sets of tracks may become misaligned. In other words, one set of tracks in the X-direction (or Y-direction) may no longer be parallel to an adjacent set of tracks in the X-direction (or Y-direction), or the first and second sets of tracks may no longer be perpendicular. Similarly, a section of the tracks in the X-direction (or Y-direction) may become damaged. For example, a guide on the tracks for the wheels of the load-handling device may deform or bend inwards such that the sides of the wheels of the load-handling device experience higher friction when passing the deformed section. As another example, there may be a damaged intersection, i.e. the point where the X-direction and Y-direction tracks cross and are joined by nuts/bolts, welding or any suitable joining means. A section of the tracks in the X-direction (or Y-direction) may become disconnected (perhaps due to a failure of the joining means) from the intersection and cause a decline for a load-handling device moving towards the intersection, followed by a sharp incline (or upwards judder) when moving onto the intersection. Similarly, a section of the tracks in the X-direction (or Y-direction) may move upwards causing an incline for a load-handling device moving towards the intersection, followed by a sharp decline (or downwards judder) when moving onto the intersection.

It is important to identify any such defects to ensure reliable operation of the storage and fulfilment system. Due to the significant size of the horizontal grid structure 15 and the significant number of load-handling devices, it is difficult, if not impossible, to observe any such defect, either directly via visual inspection or indirectly via a camera. Further, the defect may be subtle in nature and not easily identified, whilst still adversely affecting the reliable operation of the storage and fulfilment system. A method and system for detecting track defects is required.

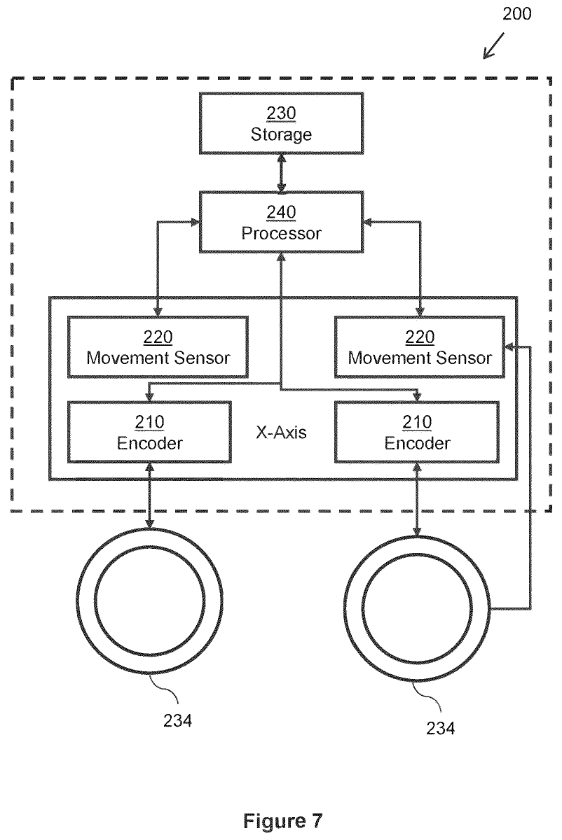

FIG. 7 shows a schematic of load-handling device 200 in accordance with the invention. One or more encoders 210 are used for a plurality of wheels of the load-handling device, which are previously described for detecting positioning of the load-handling device on the horizontal grid structure 15. The one or more encoders are within the load-handling device in this example. In FIG. 7, only a pair of wheels 234 for moving the load-handling device 30 in the X-direction on the grid structure 115 are shown. However, the complete set of wheels for each of the X-and Y-directions, e.g. the first set 134 and second set 136 of wheels described in earlier examples, can be included.

In addition, at least one movement sensor 220 is used to monitor movement of the load-handling device. The output of movement sensor 220 indicates whether the load-handling device is moving unimpeded and thus “normally” along the horizontal grid structure 15. Movement sensor 220 also indicates whether the movement of the load-handling device is “abnormal” due to being impeded by a defect on the horizontal grid structure 15. In more general terms, the movement sensor is configured to monitor movement of the load-handing device as it moves along the first and/or second sets of tracks, and generate data that can be used to distinguish between “normal” and “abnormal” movement of the load-handing device. How data from the movement sensor 220 is used to distinguish between “normal” and “abnormal” is explained in more detail below. Movement sensor 220 could take the form of an accelerometer, an inertial measurement unit, a gyroscope, an encoder or a torque sensor coupled to at least one wheel or axel of the load-handling device.

Although in FIG. 7, encoder 210 is used to determine position and the movement sensor 220 are shown as separate elements, it would be appreciated that the encoder can also be configured to monitor movement. For example, the encoder can detect a pattern associated with “normal” movement of the load-handling device, and deviation from the expected pattern could be indicative of “abnormal” movement of the load-handling device. Put another way, a single sensor can be used to detect positioning and monitor movement of the load-handling device. Load-handling device 200 can process data from encoder 210 and movement sensor using processor 240, and store this data in storage 230. The data in storage 230 can be periodically transmitted for further processing via one or more networks, such as base stations.

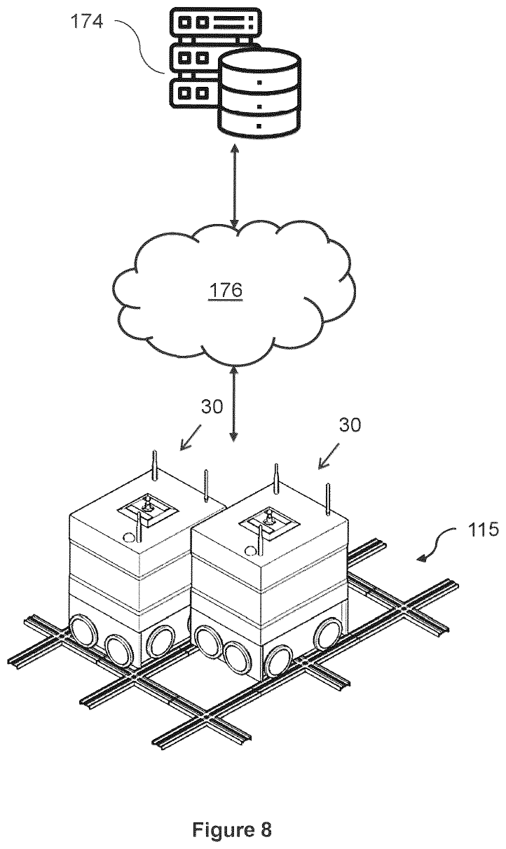

FIG. 8 shows that each load-handling device transmits the data to computing device 174 via network 176. Thus, data related to the monitored movement and positioning of each load-handling device 30 on horizontal grid structure 15 is obtained by computing device 174.

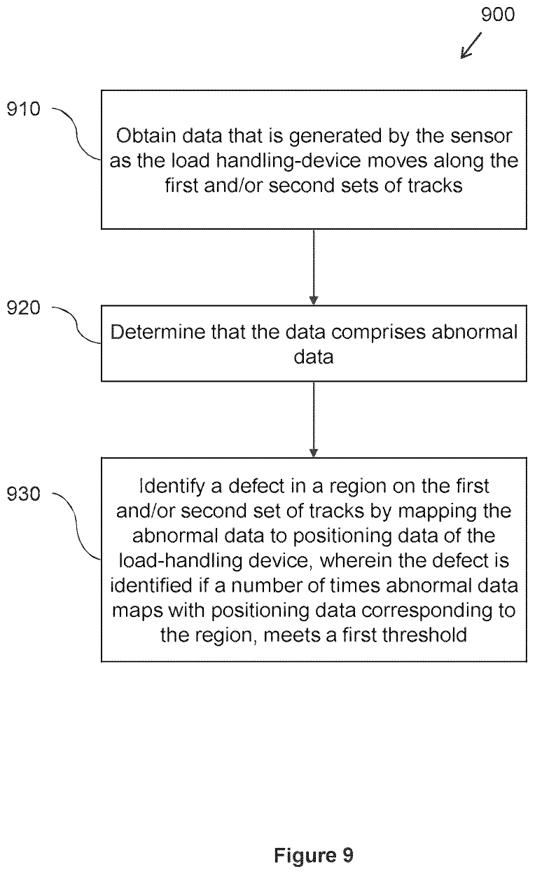

FIG. 9 shows the steps of a method 900 for determining a defect in a system. The system comprises a load-handling device 30, a first set of tracks 17 extending in a first direction and a second set of tracks 19 extending in a second direction which is transverse to the first direction, the load-handling device being configured to move on the tracks, wherein the load-handling device comprises a sensor configured to monitor movement (such as that shown in FIG. 7) of the load-handling device.

In step 910, data that is generated by the sensor as the load-handling device moves along the first and/or second sets of tracks, is obtained. The data may be obtained by computing device 174, which then carries out the method of FIG. 9.

In step 920, the data is analyzed and it is determined that the data comprises abnormal data. Put another way, at least one subset or part of the data indicates that a section of the first and/or second sets of tracks impedes a load-handling device's movement. How to determine from the data that the load-handling device's movement is impeded is explained in more detail below.

In step 930, a defect in a region (a grid space for example) of the first and/or second set of tracks is identified by mapping the abnormal data to positioning data of the load-handling device, wherein the defect is identified if a number of times abnormal data maps with positioning data (generated as explained above in relation to FIG. 6 for example) corresponding to the region, meets a first threshold. In other words, if a region of the horizontal grid structure results in a load-handling device experiencing abnormal movement a significant number of times, a defect is present in the region. The mapping process can be achieved by using timestamps on the data generated by the movement sensor at step 910 and the positioning data. Alternatively, the data generated by the movement sensor at step 910 and the positioning data may be periodically combined as they are generated.

The first threshold can be set taking into account various factors such as a period over which the data is analyzed, the number and length of trips/journeys the load-handling device makes, and the size of the horizontal grid structure 15. For example, if the load-handling device covers a large area of the horizontal grid structure 15 a significant number times a day, the threshold can be set higher since it can be assumed it will visit the region several times and should therefore detect a defect on each visit. The first threshold may be a number or a percentage value, wherein the percentage value comprises a ratio of the number of times abnormal data maps with positioning data corresponding to the region over a number of times positioning data corresponds to the region. The first threshold can be set as appropriate and is used to indicate confidence that a defect is indeed present. Absent the use of a first threshold, and where a mere sole mapping of abnormal data to positioning data is used, other reasons for the abnormal data cannot be ruled out. Other reasons include normal operation where lifting/dropping of a container with significant force in an adjacent region triggered the abnormal reading, or where the movement sensor 220 recorded data inaccurately. It will of course be appreciated that the use of the first threshold is not essential and a mere sole mapping of abnormal data to positioning data can be used to flag any potential defects.

Assuming either the first and/or second set of tracks has a section free of defects, a movement sensor (e.g., 220) of a load-handling device moving along that section will record a range of data that falls within a normal distribution. In the example where the movement sensor is an accelerometer, acceleration data recorded on each axis (along the X-direction, Y-direction, and Z-direction that is transverse to both the X and Y-directions) will fall within a normal distribution. In theory, when the load-handling device is moving at a constant speed, zero acceleration should recorded by the accelerometer along the X and Y-directions. Similarly, the Z-axis should experience a constant acceleration due to gravity, but this can be corrected to be zero also. For this reason, reference data used to derive the normal distribution can also exclude acceleration and deceleration phases of the load-handling device and only include data generated as the load-handling device is moving at a constant velocity. This means that any vibration or acceleration detected is due to the defect. It will be appreciated that the normal distribution can be derived by using multiple different sections of tracks. It will also be appreciated that any one of the acceleration axes can be used to generate the normal distribution. Alternatively, all of the axes may be summed or averaged to generate the normal distribution.

After the normal distribution has been generated, comparisons with the data obtained from the movement sensor on any section of the first and/or second sets of tracks can be made. Given that the normal distribution can be derived to only include data generated as the load-handling device is moving at a constant velocity, data obtained from the movement sensor can be filtered to only include data generated as the load-handling device is moving (on any section of the first and/or second sets of tracks) at a constant velocity. The comparisons can be based on an average readings from the movement sensor derived over a period of time, such as that typically required to move across one grid space. Similarly, comparison may be based only on an axis transverse to the direction of motion, wherein the axis corresponds to one of the X-direction, Y-direction, or Z-direction. This can reduce the amount of data that has to be accumulated and compared with minimal impact on accuracy. For example, if the load-handling device is travelling in the Y-direction, the X-direction sensor axis (and vice versa) should detect lateral movement due to a deform or bend, or a rocking motion due to debris. Similarly, using just the Z-direction sensor axis will detect bumps in the track due to debris or a sharp sudden incline/decline. Certain axis can therefore be analyzed individually to determine the nature of the defect. Alternatively, data from any two or all axes can be compared to maximize accuracy, whilst still retaining the data from the individual axes to determine the nature of the defect. More generally, any axis which can detect vibration of the load-handling device can be used.

Any data obtained from the movement sensor on any section of the first and/or second sets of tracks that is outside the normal distribution can therefore be classed as abnormal. What is considered to be outside the normal distribution can be freely chosen but could be a value beyond an integer number of standard deviations, for example. Put another way, determining that data is abnormal comprises detecting that the data deviates from a mode, median, or average, by a predetermined value. Equivalently, determining that data is abnormal comprises detecting that the data exceeds and an absolute value (or its distance from 0, which is the mode, median, or mean of the normal distribution). Equivalently, the normal distribution provides a reference value from which abnormal data can be determined. Whilst, the specific example of an accelerometer has been discussed, it will be appreciated that each of an inertial measurement unit, a gyroscope, an encoder (as discussed above in relation to FIG. 7) or a torque sensor coupled to at least one wheel or axel of the load-handling device, can be used to generate a normal distribution or reference value. In general, any sensor that is capable of detecting vibration of the load-handling device is envisaged.

Further, each defect may give rise to a “signature” vibration pattern, so it is envisaged that the type of defect can be identified by analyzing the data for the presence of a “signature”. In other words, a specific defect will be reflected in a corresponding unique pattern in the data. For example, once sufficient data has been collected and analyzed, it can be deduced that debris on the first and/or second sets of tracks gives rise to a first unique pattern in the data, misalignment along and/or between the first and/or second sets of tracks gives rise to a second unique pattern in the data, a damaged section on first and/or second sets of tracks gives rise to a third unique pattern in the data, and a damaged intersection along and/or between the first and/or second sets of tracks gives rise to a fourth unique pattern in the data. This mean that the type of defect can be determined without inspecting the system first.

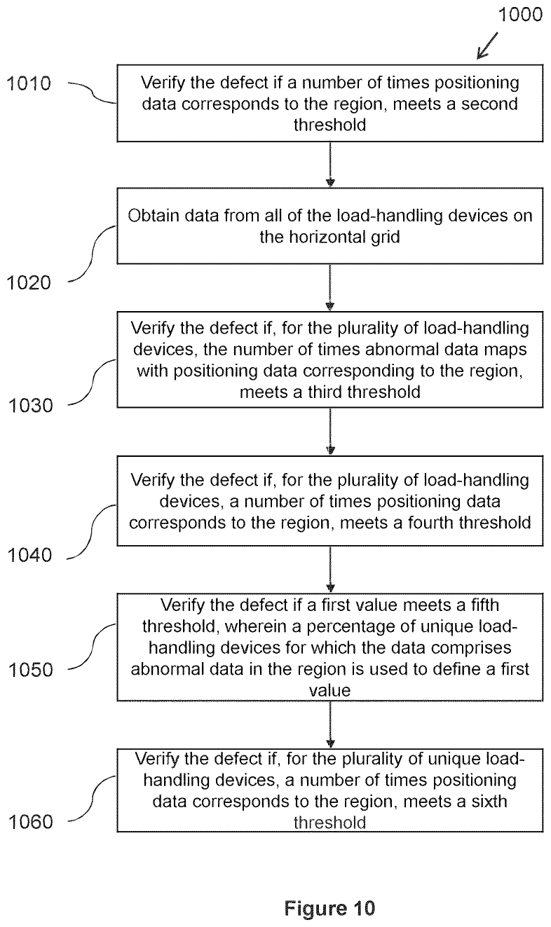

FIG. 10 shows a method 1000 to verify the defect determined by the method of FIG. 9.

In step, 1010, the method of FIG. 9 can be improved by ensuring that the load-handling device “sampled” the region a sufficient number of times. Even though the first threshold has been met, it may be based on an insufficient sample size. A second threshold can be used to ensure that the region has been sufficiently sampled. The second threshold can be set taking into account various factors such as a period over which the data is analyzed and the size of the horizontal grid structure 15. Thus, the defect is verified if a number of times positioning data corresponds to the region, meets a second threshold. It will be appreciated that instead of using the second threshold to verify the defect, both the first and second thresholds must be met before the defect is identified.

The defect can be further verified by obtaining at step 1020 data from all of the load-handling devices on the horizontal grid structure 15 to verify a defect.

In step 1030, the defect is verified if, for the plurality of load-handling devices, the number of times abnormal data maps with positioning data corresponding to the region, meets a third threshold. The third threshold can be set taking into account various factors such as a period over which the data is analyzed, the number of load-handling devices, and the size of the horizontal grid structure 15. The third threshold may be a number or a percentage value, wherein the percentage value comprises a ratio of the number of times abnormal data maps with positioning data corresponding to the region over a number of times positioning data corresponds to the region. The third threshold can be set as appropriate and is used to indicate confidence that a defect is indeed present.

In step 1040, a fourth threshold may be used to ensure that the region has been sufficiently sampled. The fourth threshold can be set taking into account various factors such as a period over which the data is analyzed, the number of load-handling devices, and the size of the horizontal grid structure 15. Thus, the defect is verified if, for the plurality of load-handling devices, a number of times positioning data corresponds to the region, meets a fourth threshold. It will be appreciated that instead of using any one or both of the third and fourth thresholds to verify the defect, all of the first, second, third, and/or fourth thresholds must be met before the defect is identified.

In step 1050, a percentage of unique load-handling devices for which the data comprises abnormal data in the region is used to define a first value. In other words, for all of the different load-handling devices in operation, it is determined how many of them generated abnormal data in the region. The greater the number of unique load-handling devices that detected abnormal motion, the chances of a defect being present are almost certain. Other explanations such as a faulty movement sensor or erroneous data transfer are unlikely to occur across multiple unique load handing devices. The defect can then be verified, if the first value meets a fifth threshold. The fifth threshold can be set taking into account various factors such as a period over which the data is analyzed, the number of unique load-handling devices, and the size of the horizontal grid structure 15. The fifth threshold may be a number or a percentage value, wherein the percentage value comprises a ratio (unique load-handling devices) of the number of times abnormal data maps with positioning data corresponding to the region over a number of times positioning data corresponds to the region. The fifth threshold can be set as appropriate and is used to indicate confidence that a defect is indeed present.

In step 1060, a sixth threshold may be used to ensure that the region has been sufficiently sampled by the unique load-handling devices. The sixth threshold can be set taking into account various factors such as a period over which the data is analyzed, the number of unique load-handling devices, and the size of the horizontal grid structure 15. Thus, the defect is verified if, for the plurality of unique load-handling devices, a number of times positioning data corresponds to the region, meets a sixth threshold. It will be appreciated that instead of using any one or both of the fifth and sixth thresholds to verify the defect, all of the first, second, third, fourth, fifth and/or sixth thresholds must be met before the defect is identified.

It will be appreciated in respect of FIG. 10, any combination of thresholds may be selected to verify or identify the defect. That is, any one or combination of the first, second, third, fourth, fifth, or sixth thresholds can be selected as appropriate.

Although the method of FIG. 10 is used to supplement the data derived from a single load-handling device, as per FIG. 9, it will be appreciated that data from all of the load-handling devices may be required before a defect can be detected. For example, the process of FIG. 9 can be modified to use data generated by each movement sensor (e.g., 220) of respective load-handling devices. Therefore, any instance of abnormal data from any load-handling device is mapped to positioning data. A defect is then identified in a region if the number of times the mapping occurs for a region meets a first threshold. The first threshold (and fourth, fifth, and sixth thresholds) previously described can of course be scaled according to the number of the load-handling devices in use. In this implementation, the first threshold may be substantially equal to the third threshold previously described.

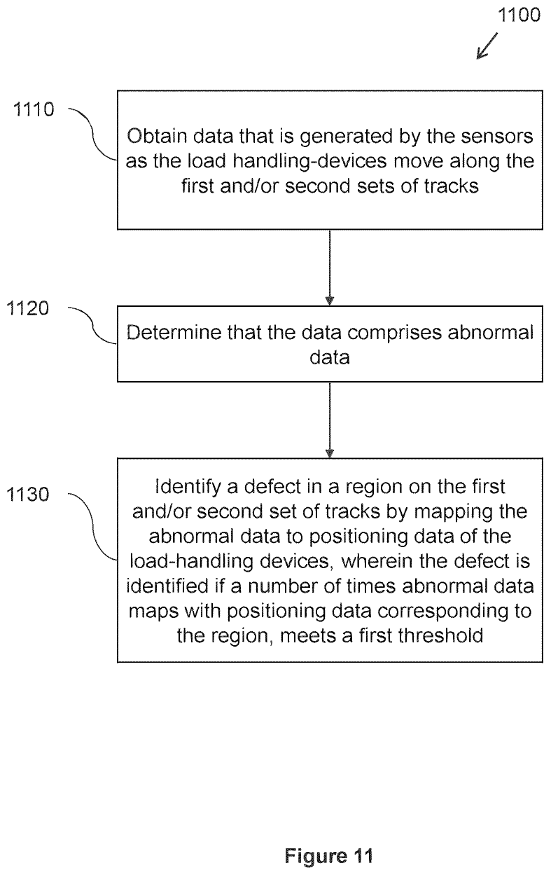

Accordingly, FIG. 11 shows the steps of a method 1100 for determining a defect in the system. The system comprises a plurality of load-handling devices 30, a first set of tracks 17 extending in a first direction and a second set of tracks 19 extending in a second direction which is transverse to the first direction, each load-handling device being configured to move on the tracks, wherein each load-handling device comprises a sensor configured to monitor movement of the load-handling device.

In step 1110, data that is generated by the sensors as the load-handling devices move along the first and/or second sets of tracks, is obtained. The data may be obtained by computing device 174, which then carries out method of FIG. 11.

In step 1120, the data is analyzed and it is determined that the data comprises abnormal data, as set out above.

In step 1130, a defect in a region (a grid space for example) on the first and/or second set of tracks is identified by mapping the abnormal data to positioning data of the load-handling devices, wherein the defect is identified if a number of times abnormal data maps with positioning data (generated as explained above for example) corresponding to the region, meets a first threshold. In other words, if a region of the horizontal grid structure results in load-handling devices experiencing abnormal movement a significant number of times, a defect is present in the region.

The defect determined by the method of FIG. 11, can be further verified by using steps 1040, 1050, and 1060 of FIG. 10. Again, it will be appreciated that instead of using the any of the fourth, fifth and sixth thresholds to verify the defect, all of the fourth, fifth and sixth thresholds must be met before the defect is identified. It will also be appreciated that any combination of thresholds may be selected to verify or identify the defect. That is, any one or combination of the first, fourth, fifth, or sixth thresholds can be selected as appropriate.

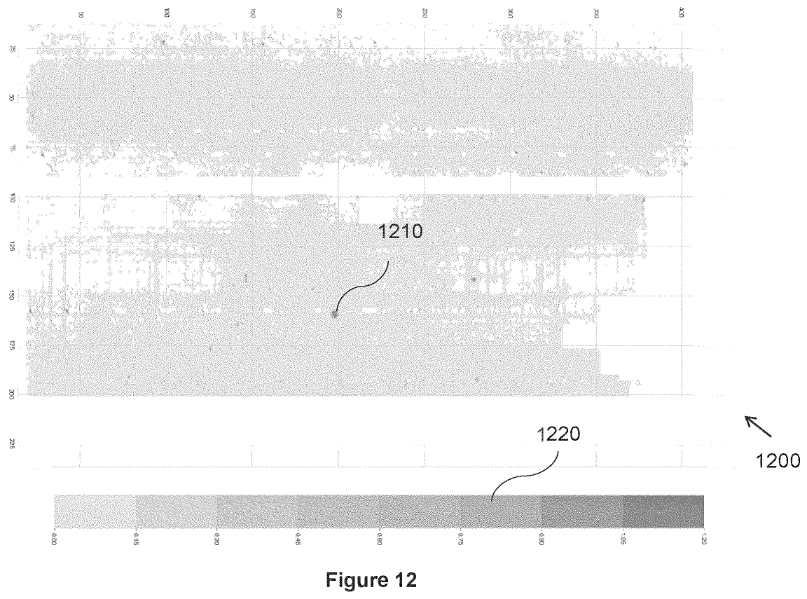

The above methods can be performed on data collected over a period of time, such as a number of hours, days, weeks, and months. Upon running the above methods, regions of the horizontal grid structure with defects can identified. Both the location and severity (i.e. persistent abnormal data) can be presented on a map (or “heat”-map). The heat-map or map is a 2D representation of the horizontal grid structure 15, where the color of a region with a defect can be used to indicate the severity of the defect. An example heat-map 1200 is shown in FIG. 12, where a region 1210 is shown as experiencing highly abnormal data (e.g. the load-handling device experiences significant vibrations when traveling in this area) in line with scale 1220. The two axes of the heat-map can be used to indicate the exact region/position of the defect. Daily snap-shots of the heat-map can be used to construct a video or time-lapse of the horizontal grid structure 15 to see how defects have developed over time.

Whilst the above methods have been described in the context of detecting defects, it will be appreciated that the same methods can readily detect normal operation of the system. That is, if the movement sensors only generate normal data, the grid can be assumed to be free of defects. This is particularly useful when verifying whether newly built tracks and/or repairs are robust.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention can take the form of an entirely hardware embodiment, an entirely software embodiment or an embodiment containing both hardware and software elements. In a preferred embodiment, the invention is implemented in software.

Furthermore, the invention can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various embodiments of the present invention. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

### EXAMPLE EMBODIMENTS

The following is a non-exhaustive list of embodiments which may be or are claimed:

Embodiment 1. A computer-implemented method for determining a defect in a system, the system comprising a load-handling device (30), a first set of tracks (17) extending in a first direction and a second set of tracks (19) extending in a second direction which is transverse to the first direction, the load-handling device being configured to move on the tracks, wherein the load-handling device comprises a sensor configured to monitor movement of the load-handling device, wherein the method comprises: obtaining data that is generated by the sensor as the load-handling device moves along the first and/or second sets of tracks; determining that the data comprises abnormal data; and identifying a defect in a region of the first and/or second set of tracks by mapping the abnormal data to positioning data of the load-handling device.

Embodiment 2. The method of embodiment 1, wherein the defect is identified if a number of times abnormal data maps with positioning data corresponding to the region, meets a first threshold.

Embodiment 3. The method of any preceding embodiment, wherein the sensor detects vibration of the load-handling device as it moves along the first and/or second sets of tracks.

Embodiment 4. The method of any preceding embodiment, wherein the sensor comprises an accelerometer, an inertial measurement unit, a gyroscope, an encoder or a torque sensor coupled to at least one wheel or axel of the load-handling device.

Embodiment 5. The method of any preceding embodiment, wherein determining that data is abnormal comprises detecting that the data: deviates from a mode, median, or mean, by a predetermined value; or exceeds a reference value.

Embodiment 6. The method of any preceding embodiment, wherein data generated by the sensor during acceleration and deceleration of the load-handling device is excluded, such that the load-handling device is traveling at a constant velocity when determining that data comprises abnormal data.

Embodiment 7. The method of any preceding embodiment, wherein the sensor only generates data in an axis transverse to a direction of movement of the load-handling device.

Embodiment 8. The method of embodiments 1 to 6, wherein the sensor generates data in a first axis corresponding to the first direction, a second axis corresponding to the second direction, and a third axis transverse to the first and second directions.

Embodiment 9. The method of any preceding embodiment, wherein the first threshold is a number or a percentage value, and optionally wherein the percentage value comprises a ratio of the number of times abnormal data maps with positioning data corresponding to the region over a number of times positioning data corresponds to the region.

Embodiment 10. The method of any preceding embodiment, wherein the defect is verified if a number of times positioning data corresponds to the region, meets a second threshold.

Embodiment 11. The method of any preceding embodiment, wherein the system comprises a plurality of load-handling devices, wherein the defect is verified if, for the plurality of load-handling devices, the number of times abnormal data maps with positioning data corresponding to the region, meets a third threshold.

Embodiment 12. The method of embodiment 11, wherein the defect is verified, if, for the plurality of load-handling devices, a number of times positioning data corresponds to the region, meets a fourth threshold.

Embodiment 13. The method of embodiments 1 to 10, wherein the system comprises a plurality of load-handling devices, wherein the method further comprises: determining a percentage of unique load-handling devices for which the data comprises abnormal data in the region to define a first value; and verifying that a defect is in the region if the first value exceeds a fifth threshold.

Embodiment 14. The method of embodiments 1 to 10, wherein the system comprises a plurality of load-handling devices, wherein the method further comprises: determining a total number of unique load-handling devices with positioning data corresponding to the region to define a second value; and verifying that a defect is in the region if the second value exceeds a sixth threshold.

Embodiment 15. The method of embodiments 10 to 14, wherein the first, second, third, fourth, fifth, and sixth thresholds are each met, or any combination of the first, second, third, fourth, fifth, and sixth thresholds are met to verify that a defect is in the region.

Embodiment 16. The method of any preceding embodiment, wherein the method further comprises determining a type of the defect by detecting a corresponding unique pattern in the data.

Embodiment 17. The method of any preceding embodiment, wherein a type of the defect comprises at least one of: debris on the first and/or second sets of tracks; misalignment along and/or between the first and/or second sets of tracks; a damaged section on first and/or second sets of tracks; or a damaged intersection along and/or between the first and/or second sets of tracks.

Embodiment 18. The method of any preceding embodiment, wherein the first and second set of tracks are in a substantially horizontal plane to form a grid comprising a plurality of grid spaces, to form a plurality of vertical storage locations beneath the grid for containers to be stacked between and be guided by uprights in a vertical direction through the plurality of grid spaces, and optionally wherein the or each load-handling device is configured to lift a container from a vertical storage location beneath the grid and/or lower a container into a vertical storage location.

Embodiment 19. The method of embodiment 18, wherein the region comprises a grid space, and the method optionally further comprises reconfiguring the system to avoid operating the or each load-handling device in the grid space.

Embodiment 20. The method of embodiment 19, wherein the data comprises a plurality of average values, wherein each average value is derived from the sensor when the load-handling device is moving across a respective grid space.

Embodiment 21. The method of any preceding embodiment, wherein the method is performed over a predefined period of time.

Embodiment 22. The method of any preceding embodiment, further comprising generating a map, wherein the map indicates regions with defects within the system.

Embodiment 23. A computer program comprising instructions which, when the program is executed by a computer, cause the computer to carry out the method of embodiments 1 to 22.

Embodiment 24. A data processing system comprising a processor configured to carry out the method of embodiments 1 to 22.

Embodiment 25. A system comprising: a load-handling device (30), a first set of tracks (17) extending in a first direction and a second set of tracks (19) extending in a second direction which is transverse to the first direction, the load-handling device being configured to move on the tracks, wherein the load-handling device comprises a sensor configured to monitor movement of the load-handling device; and the data processing system of embodiment 24.

Embodiment 26. A map, wherein the map is generated using the method of embodiments 1 to 212, the computer program of embodiment 23, or the system of embodiments 24 or 25, the map indicating regions with defects within the system.

Embodiment 27. A computer-implemented method for determining a defect in a system, the system comprising a plurality of load-handling device (30), a first set of tracks (17) extending in a first direction and a second set of tracks (19) extending in a second direction which is transverse to the first direction, the load-handling device being configured to move on the tracks, wherein each load-handling device comprises a sensor configured to monitor movement of the load-handling device, wherein the method comprises: obtaining data that is generated by the sensor as the load-handling device moves along the first and/or second sets of tracks; determining that the data comprises abnormal data; and identifying a defect in a region of the first and/or second set of tracks by mapping the abnormal data to positioning data of the load-handling device.

Embodiment 28. The method of embodiment 27, wherein the defect is identified if a number of times abnormal data maps with positioning data corresponding to the region, meets a first threshold.

Embodiment 29. The method of embodiments 27 or 28, wherein the sensor detects vibration of the load-handling device as it moves along the first and/or second sets of tracks.

Embodiment 30. The method of embodiments 27 to 29, wherein the sensor comprises an accelerometer, an inertial measurement unit, a gyroscope, an encoder or a torque sensor coupled to at least one wheel or axel of the load-handling device.

Embodiment 31. The method of embodiments 27 to 30, wherein determining that data is abnormal comprises detecting that the data: deviates from a mode, median, or mean, by a predetermined value; or exceeds a reference value.

Embodiment 32. The method of embodiments 27 to 31, wherein data generated by the sensor during acceleration and deceleration of the load-handling devices is excluded, such that the load-handling devices are traveling at a constant velocity when determining that data comprises abnormal data.

Embodiment 33. The method of embodiments 27 to 32, wherein the sensor only generates data in an axis transverse to a direction of movement of a load-handling device.

Embodiment 34. The method of embodiments 27 to 33, wherein the sensor generates data in a first axis corresponding to the first direction, a second axis corresponding to the second direction, and a third axis transverse to the first and second directions.

Embodiment 35. The method of embodiments 27 to 34, wherein the first threshold is a number or a percentage value, and optionally wherein the percentage value comprises a ratio of the number of times abnormal data maps with positioning data corresponding to the region over a number of times positioning data corresponds to the region.

Embodiment 36. The method of embodiments 27 to 35, wherein the defect is verified if, for the plurality of load-handling devices, a number of times positioning data corresponds to the region, meets a second threshold.

Embodiment 37. The method of embodiments 27 to 36, wherein the method further comprises: determining a percentage of unique load-handling devices for which the data comprises abnormal data in the region to define a first value; and verifying that a defect is in the region if the first value exceeds a fifth threshold.

Embodiment 38. The method of embodiments 26 to 37, wherein the method further comprises: determining a total number of unique load-handling devices with positioning data corresponding to the region to define a second value; and verifying that a defect is in the region if the second value exceeds a sixth threshold.

Embodiment 39. The method of embodiments 35 to 38, wherein the first, second, fifth, and sixth thresholds are each met, or any combination of the first, second, fifth, and sixth thresholds are met to verify that a defect is in the region.

Embodiment 40. The method of embodiments 26 to 39, wherein the method further comprises determining a type of the defect by detecting a corresponding unique pattern in the data.

Embodiment 41. The method of any preceding embodiment, wherein a type of the defect comprises at least one of: debris on the first and/or second sets of tracks; misalignment along and/or between the first and/or second sets of tracks; a damaged section on first and/or second sets of tracks; or a damaged intersection along and/or between the first and/or second sets of tracks.

Embodiment 42. The method of embodiments 27 to 41, wherein the first and second set of tracks are in a substantially horizontal plane to form a grid comprising a plurality of grid spaces, to form a plurality of vertical storage locations beneath the grid for containers to be stacked between and be guided by uprights in a vertical direction through the plurality of grid spaces, and optionally wherein the or each load-handling device is configured to lift a container from a vertical storage location beneath the grid and/or lower a container into a vertical storage location.

Embodiment 43. The method of embodiment 42, wherein the region comprises a grid space, and the method optionally further comprises reconfiguring the system to avoid operating the or each load-handling device in the grid space.

Embodiment 44. The method of embodiment 43, wherein the data comprises a plurality of average values, wherein each average value is derived from the sensor when the load-handling device is moving across a respective grid space.

Embodiment 45. The method of embodiments 27 to 44, wherein the method is performed over a predefined period of time.

Embodiment 46. The method of embodiments 27 to 45, further comprising generating a map, wherein the map indicates regions with defects within the system.

Embodiment 47. A computer program comprising instructions which, when the program is executed by a computer, cause the computer to carry out the method of embodiments 27 to 46.

Embodiment 48. A data processing system comprising a processor configured to carry out the method of embodiments 27 to 47.

Embodiment 49. A system comprising: a plurality of load-handling devices, a first set of tracks extending in a first direction and a second set of tracks extending in a second direction which is transverse to the first direction, the load-handling device being configured to move on the tracks, wherein each load-handling device comprises a sensor configured to monitor movement of the load-handling device; and the data processing system of embodiment 48.

Embodiment 50. A map, wherein the map is generated using the method of embodiments 27 to 46, the computer program of embodiment 47, or the system of embodiments 48 or 49, the map indicating regions with defects within the system.

Embodiment 51. A computer-implemented method for verifying a system build and/or repair, the system comprising a load-handling device, a first set of tracks extending in a first direction and a second set of tracks extending in a second direction which is transverse to the first direction, the load-handling device being configured to move on the tracks, wherein the load-handling device comprises a sensor configured to monitor movement of the load-handling device, wherein the method comprises: obtaining data that is generated by the sensor as the load-handling device moves along the first and/or second sets of tracks; determining that the data comprises normal data; and verifying a system build and/or repair in a region of the first and/or second set of tracks by mapping the normal data to positioning data of the load-handling device.

Embodiment 52. The method of embodiment 51, wherein the build and/or repair is verified if a number of times normal data maps with positioning data corresponding to the region, meets a first threshold.

Embodiment 53. The method of embodiments 51 or 52, wherein the sensor detects vibration of the load-handling device as it moves along the first and/or second sets of tracks.

Embodiment 54. The method of embodiments 51 to 53, wherein the sensor comprises an accelerometer, an inertial measurement unit, a gyroscope, an encoder or a torque sensor coupled to at least one wheel or axel of the load-handling device.

Embodiment 55. The method of embodiments 51 to 54, wherein determining that data is normal comprises detecting that the data: deviates from a mode, median, or mean, by less than a predetermined value; or is less than a reference value.

Embodiment 56. The method of embodiments 51 to 55, wherein data generated by the sensor during acceleration and deceleration of the load-handling device is excluded, such that the load-handling device is traveling at a constant velocity when determining that data comprises normal data.

Embodiment 57. The method of embodiments 51 to 56, wherein the sensor only generates data in an axis transverse to a direction of movement of the load-handling device.

Embodiment 58. The method of embodiments 51 to 57, wherein the sensor generates data in a first axis corresponding to the first direction, a second axis corresponding to the second direction, and a third axis transverse to the first and second directions.

Embodiment 59. The method of embodiments 51 to 58, wherein the first threshold is a number or a percentage value, and optionally wherein the percentage value comprises a ratio of the number of times normal data maps with positioning data corresponding to the region over a number of times positioning data corresponds to the region.

Embodiment 60. The method of embodiments 51 to 59, wherein the build and/or repair is verified if a number of times positioning data corresponds to the region, meets a second threshold.

Embodiment 61. The method of embodiments 51 to 60, wherein the system comprises a plurality of load-handling devices, wherein the build and/or repair is verified if, for the plurality of load-handling devices, the number of times normal data maps with positioning data corresponding to the region, meets a third threshold.

Embodiment 62. The method of embodiment 61, wherein the build and/or repair is verified, if, for the plurality of load-handling devices, a number of times positioning data corresponds to the region, meets a fourth threshold.

Embodiment 63. The method of embodiments 51 to 60, wherein the system comprises a plurality of load-handling devices, wherein the method further comprises: determining a percentage of unique load-handling devices for which the data comprises abnormal data in the region to define a first value; and verifying the build and/or repair if the first value exceeds a fifth threshold.

Embodiment 64. The method of embodiments 51 to 60, wherein the system comprises a plurality of load-handling devices, wherein the method further comprises: determining a total number of unique load-handling devices with positioning data corresponding to the region to define a second value; and verifying that a defect is in the region if the second value exceeds a sixth threshold.

Embodiment 65. The method of embodiments 60 to 64, wherein the first, second, third, fourth, fifth, and sixth thresholds are each met, or any combination of the first, second, third, fourth, fifth, and sixth thresholds are met to verify that a defect is in the region.

Embodiment 66. The method of embodiments 51 to 65, wherein the verifying the build and/or repair comprises determining at least one of: absence of debris on the first and/or second sets of tracks; alignment along and/or between the first and/or second sets of tracks; an undamaged section on first and/or second sets of tracks; or an undamaged intersection along and/or between the first and/or second sets of tracks.

Embodiment 67. The method of embodiments 51 to 66, wherein the first and second set of tracks are in a substantially horizontal plane to form a grid comprising a plurality of grid spaces, to form a plurality of vertical storage locations beneath the grid for containers to be stacked between and be guided by uprights in a vertical direction through the plurality of grid spaces, and optionally wherein the or each load-handling device is configured to lift a container from a vertical storage location beneath the grid and/or lower a container into a vertical storage location.

Embodiment 68. The method of embodiment 67, wherein the region comprises a grid space, and the method optionally further comprises reconfiguring the system to avoid operating the or each load-handling device on the grid space unless the build and/or repair has been verified.

Embodiment 69. The method of embodiment 68, wherein the data comprises a plurality of average values, wherein each average value is derived from the sensor when the load-handling device is moving across a respective grid space.

Embodiment 70. The method of embodiments 51 to 69, wherein the method is performed over a predefined period of time.

Embodiment 71. The method of embodiments 51 to 70, further comprising generating a map, wherein the map indicates regions within the system in which the build and/or repair has been verified.

Embodiment 72. A computer program comprising instructions which, when the program is executed by a computer, cause the computer to carry out the method of embodiments 51 to 71.

Embodiment 73. A data processing system comprising a processor configured to carry out the method of embodiments 51 to 71.

Embodiment 74. A system comprising: a load-handling device, a first set of tracks extending in a first direction and a second set of tracks extending in a second direction which is transverse to the first direction, the load-handling device being configured to move on the tracks, wherein the load-handling device comprises a sensor configured to monitor movement of the load-handling device; and the data processing system of embodiment 73.

Embodiment 75. A map, wherein the map is generated using the method of embodiments 51 to 71, the computer program of embodiment 72, or the system of embodiments 73 or 74, wherein the map indicates regions within the system in which the build and/or repair has been verified.

What is claimed is:

1. A computer-implemented method for determining a defect in a system, wherein:
the system comprises:
a first set of tracks extending in a first direction and a second set of tracks extending in a second direction, transverse to the first direction, wherein the first set of tracks and the second set of tracks are in a substantially horizontal plane to form a grid comprising a plurality of grid spaces to form a plurality of vertical storage locations beneath the grid for containers to be stacked between and to be guided by uprights in a vertical direction through the plurality of grid spaces;
a plurality of load-handling device, wherein:
each load-handling device of the plurality of load-handling devices is configured to move on the first set of tracks and the second set of tracks,
each load-handling device of the plurality of load-handling devices is configured to lift a container from a vertical storage location beneath the grid, transport a container from a vertical storage location beneath the grid, lower a container into a vertical storage location beneath the grid, and/or transport a container into a vertical storage location beneath the grid, and
each respective load-handling device of the plurality of load-handling devices comprises a sensor configured to monitor movement of the respective load-handling device, and
the method comprises:
obtaining data generated by a sensor of at least one load-handling device of the plurality of load-handling devices as the at least one load-handling device moves along the first sets of tracks or the second set of tracks;
determining that the data comprises abnormal data; and
identifying a defect in a region of the first set of tracks or the second set of tracks by mapping the abnormal data to positioning data of the at least one load-handling device.

2. The method of claim 1, wherein the method further comprises:
obtaining data generated by a sensor of each respective load-handling device of the plurality of load-handling devices as the respective load-handling device moves along the first sets of tracks or the second set of tracks;
determining, for each respective load-handling device of the plurality of load-handling devices, whether data generated by the sensor of the respective load-handling device comprises abnormal data;
determining a percentage of load-handling devices of the plurality of load-handling devices generating abnormal data in the region of the first set of tracks or the second set of tracks to define a first value; and
verifying that a defect is in the region of the first set of tracks or the second set of tracks if the first value exceeds a first threshold.

3. The method of claim 1, wherein the method further comprises:
determining a total number of unique load-handling devices of the plurality of load-handling devices associated with positioning data corresponding to the region of the first set of tracks or the second set of tracks to define a second value; and
verifying that a defect is in the region of the first set of tracks or the second set of tracks if the second value exceeds a second threshold.

4. The method of claim 1, wherein the sensor detects vibration of the at least one load-handling device as it moves along the first set of tracks or the second sets of tracks.

5. The method of claim 1, wherein the sensor comprises an accelerometer, an inertial measurement unit, a gyroscope, an encoder, or a torque sensor coupled to at least one wheel or axel of the at least one load-handling device.

6. The method of claim 1, wherein determining that data is abnormal comprises determining that the data:
deviates from a mode, median, or mean, by a predetermined value; or
exceeds a reference value.

7. The method of claim 1, wherein data generated by the sensor during acceleration and deceleration of the at least one load-handling device is excluded, such that determining that the data comprises abnormal data is based on the at least one load-handling device traveling at a constant velocity.

8. The method of claim 1, wherein the sensor only generates data in an axis transverse to a direction of movement of the at least one load-handling device.

9. The method of claim 1, wherein the sensor generates data in a first axis corresponding to the first direction, a second axis corresponding to the second direction, and a third axis transverse to the first and second directions.

10. The method of claim 1, wherein the method further comprises determining a type of the defect by detecting a corresponding unique pattern in the data.

11. The method of claim 10, wherein a type of the defect comprises at least one of:
debris on the first and/or second sets of tracks;
misalignment along and/or between the first and/or second sets of tracks;
a damaged section on first and/or second sets of tracks; or
a damaged intersection along and/or between the first and/or second sets of tracks.

12. The method of claim 1, wherein:
the region comprises a grid space, and
the method further comprises reconfiguring the system to avoid operating each load-handling device of the plurality of load-handling devices in the grid space.

13. The method of claim 1, wherein:
the data comprises a plurality of average values, and
each average value of the plurality of average values is derived from the sensor when the at least one load-handling device is moving across a respective grid space.

14. The method of claim 1, wherein the method is performed over a predefined period of time.

15. The method of claim 1, further comprising:
generating a map,
wherein the map indicates one or more regions with defects within the system.

16. A computer program comprising instructions which, when the program is executed by a computer, cause the computer to carry a method, comprising:
obtaining data generated by a sensor of at least one load-handling device of a plurality of load-handling devices as the at least one load-handling device moves along a first sets of tracks or a second set of tracks;
determining that the data comprises abnormal data; and
identifying a defect in a region of the first set of tracks or the second set of tracks by mapping the abnormal data to positioning data of the at least one load-handling device,
wherein:
the first set of tracks extends in a first direction and the second set of tracks extends in a second direction, transverse to the first direction,
the first set of tracks and the second set of tracks are in a substantially horizontal plane to form a grid comprising a plurality of grid spaces to form a plurality of vertical storage locations beneath the grid for containers to be stacked,
the at least one load-handling device is configured to move on the first set of tracks and the second set of tracks,
the at least one load-handling device is configured to lift a container from a vertical storage location beneath the grid, transport the container from a vertical storage location beneath the grid, lower the container into a vertical storage location beneath the grid, and/or transport the container into a vertical storage location beneath the grid, and
the at least one load-handling devices comprises a sensor configured to monitor movement of the load-handling device.

17. A system, comprising:
a first set of tracks extending in a first direction;
a second set of tracks extending in a second direction that is transverse to the first direction;
a plurality of load-handling devices, each respective load-handling device of the plurality of load-handling devices being configured to move on the first set of tracks and the second set of tracks, and comprising a sensor configured to monitor movement of the respective load-handling device; and
a processor configured to cause the system to:
obtain data generated by a sensor of at least one load-handling device of the plurality of load-handling devices as the at least one load-handling device moves along the first sets of tracks or the second set of tracks;
determine that the data comprises abnormal data; and
identify a defect in a region of the first set of tracks or the second set of tracks by mapping the abnormal data to positioning data of the at least one load-handling device.
